(19) United States
(12) Patent Application Publication
(10) Pub. No.: US 2007/0010921 A1
(43) Pub. Date: Jan. 11, 2007

(54) METHOD, APPARATUS, AND DATABASE PRODUCTS FOR AUTOMATED RUNWAY SELECTION

(75) Inventors: Yasuo Ishihara, Kirkland, WA (US); Scott R. Gremmert, Redmond, WA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/160,680

(22) Filed: Jul. 5, 2005

(51) Int. Cl. G01C 21/00

(52) U.S. Cl. 701/16; 340/972

(57) ABSTRACT

An apparatus, method and database for predicting which one of at least two candidate runways on which an aircraft is most likely to land includes a database. The database is configured to contain at least two runway data. The runway data includes an empirical glide slope angle and a location associated with each candidate runway. A position sensor is configured to determine a position of the aircraft. A processor is configured to retrieve the glide slope angle and location data associated with each of the at least two candidate runways. The processor calculates an aircraft glide slope angle relative to each of the at least two candidate runways based upon the position of the aircraft, and derives a first likelihood of landing value for each of the at least two candidate runways based upon the empirical glide slope angle and the aircraft glide slope angle associated with the runway.

### BACKGROUND

Development of ground proximity warning systems has advanced safety in aircraft flight. The flight parameters of the aircraft and the terrain surrounding the aircraft trigger alerts to the flight crew given a likelihood of collision with either terrain or other obstacles. In spite of the utility of in-flight warnings, the utility of these systems must be balanced against diverting attention of the flight crew with false alerts, ultimately training the flight crew to ignore alarms from the ground proximity warning system altogether.

In landing, ground proximity warning systems, if not adequately controlled, may generate unwanted alarms as the aircraft nears the earth. Undue or nuisance alarms during landing are a distraction and contribute to stress attendant to a successful landing. Additionally, the nuisance alarms may distract from critical alarms sounding in the cockpit.

Ground proximity warning systems have been developed that evaluate the proximity of the aircraft to an airport and the flight altitude of the aircraft above the runway to determine if the aircraft is entering a landing procedure. For example, one ground proximity warning system monitors the altitude of the aircraft in relation to the runway closest to the aircraft. If the aircraft approaches the runway within a predetermined distance range and within a predetermined altitude range, the ground proximity warning system will determine that the aircraft is entering a landing procedure. Selection of a runway according to a glide slope angle is discussed in detail in U.S. Pat. No. 6,304,800, entitled “Methods, Apparatus And Computer Program Products For Automated Runway Selection” which is assigned to the assignee of the present application. The teaching of U.S. Pat. No. 6,304,800 is incorporated herein by reference.

With reference to FIG. 1, selection of a runway works in a landing maneuver 74 on a candidate runway 64 by comparing terrain elevation in an immediate vicinity of an aircraft 62 to a predefined acceptable approach envelope 66. The approach envelope 66 is defined with reference to the aircraft 62, is configured to determine whether an aircraft is at an acceptable altitude and distance such that it is likely to land on a candidate runway.

To determine an acceptable altitude and distance throughout the course of the landing maneuver, a ground proximity warning system defines the approach envelope 66 detailing altitude and distance parameters defining positions suitable for the aircraft 62 as the aircraft lands on the candidate runway 64. The approach envelope 66 includes an outer distance boundary 68 that defines the maximum distance that the aircraft 62 can be from the candidate runway before the candidate runway will be considered, shown in nonlimiting example as five nautical miles. The outer distance boundary 68 is typically chosen based on the need to provide adequate alarm protection, while at the same time reduce the number of nuisance alarms generated.

The approach envelope 66 also includes an upper altitude boundary 70. The upper altitude boundary 70 defines the maximum altitude that the aircraft 62 can be above the candidate runway 64 and the candidate runway 64 still be considered as the candidate runway 64.

Within the outer distance boundary 68 and upper altitude boundary 70, the approach envelope 66 further includes an upper landing envelope ceiling 72. The upper landing envelope ceiling 72 is considered to be at too high an altitude above the candidate runway 64 in relation to the distance the aircraft 62 is from the candidate runway 64. The upper landing envelope ceiling 72 is typically defined with respect to a lower glide slope angle 86 multiplied by the distance the aircraft 62 is from the candidate runway 64 (i.e., Predefined Altitude Distance to Runway), and in typical embodiments, the predefined altitude is 700 ft./nautical mile. The 700 ft predefined altitude is a nonlimiting example but is chosen as it represents the upper glide slope angle of 7 degrees consistent with performance typical of commercial aircraft.

Customarily, when within a designatable proximity to the candidate runway 64, the upper landing envelope ceiling 72 is defined to include a flat or 0 degree slope portion 76. In recognition that runway elevation errors or height errors may tend to cause the aircraft 62 to be flying a constant height over the runway 64 rather than on it, the appropriate envelope 66 allows for such errors without sounding an alert. The flat angle approach is used as a non-limiting example of a configurable lower limit. Additionally the aircraft 62 may be engaged in a circling pattern before landing on the runway 64.

Additionally, the approach angle envelope 66 also includes a lower landing envelope floor 78. The lower landing envelope floor 78 includes first and second floor threshold functions, 80 and 82, respectively. The first portion of the floor threshold 80 of the landing envelope floor 78 meets a lower glide slope angle 86 projection. An aircraft 62 in a region 84 below the landing envelope floor 78 is considered to have too low an altitude for the distance between the aircraft 62 and the candidate runway 64 for the aircraft 62 to be landing on the runway 64. Similar to the upper ceiling 72, the slope of the first portion of the landing envelope floor 78 is typically based on a predefined altitude multiplied by the distance the aircraft is from the runway.

Use of the closest runway to the aircraft 62, however, is not always an optimal solution where several runways are geographically close to one another when the aircraft 62 approaches the airport from one direction with intentions of landing on a runway on the opposite side of the airport. In these instances, the ground proximity warning system prematurely disables or desensitizes the alarms. Where two airports at different elevations above sea level are located in close proximity to one another, and the aircraft 62 flies near one airport at low altitude in route to the second airport, the ground proximity warning system will use the closest runway of the first airport in the creation of the terrain floor. Based on the distance from the closest runway, the ground proximity warning system will generate terrain caution or terrain warning alerts based upon the incorrect assumption that the aircraft 62 is landing at the first airport.

While commercial aviation generally uses a 3 degree glide path as the regular approach for landing, such aviation is not constrained to do so and may use a glide slope as little as 0 degrees to as much as 7 degrees. Topography proximate to the airport often dictates the most advantageous glide slope angle. Known ground proximity warning systems have no means by which to differentiate between landing on smooth unobstructed terrain and more challenging approaches.

What is needed in the art is a ground proximity warning apparatus with a facility to predict a more likely runway from among several candidate runways based upon data stored in association with each of the candidate runways.

### SUMMARY

An apparatus, method and database for predicting which one of at least two candidate runways on which an aircraft is most likely to land includes a database. The database is configured to contain at least two runway data. The runway data includes an empirical glide slope angle and a location associated with each candidate runway. A position sensor is configured to determine a position of the aircraft. A processor is configured to retrieve the glide slope angle and location data associated with each of the at least two candidate runways. The processor calculates an aircraft glide slope angle relative to each of the at least two candidate runways based upon the position of the aircraft, and derives a first likelihood for each of the at least two candidate runways based upon the empirical glide slope angle and the aircraft glide slope angle associated with the runway.

In accord with further embodiments, the database includes runway data stored in association with each of a plurality of runways. The runway data includes a location datum. The location datum is configured to fix the runway in a spherical coordinate system. The runway data also includes an empirical glide slope angle. The empirical glide slope angle selected to represent a most likely glide slope to approach the runway.

As will be readily appreciated from the foregoing summary, the processor orders candidate runways based upon an empirical probability model based upon the glide slope angle. A likelihood of landing value is ascribed to each of the candidate runways based upon an aircraft position and the empirical probability model. The likelihood of landing value is then used by the processor to order the runways and select a most likely runway.

### BRIEF DESCRIPTION OF THE DRAWINGS

The preferred and alternative embodiments of the present invention are described in detail below with reference to the following drawings.

FIG. 1 is a plan view illustrating graphically an acceptable approach envelope that defines whether an aircraft is at an acceptable altitude and distance from a candidate runway according to one embodiment;

FIG. 2 is a block diagram of an apparatus for predicting upon which of at least two candidate runways that an aircraft is most likely to land according to one embodiment;

FIG. 3 is a top view illustrating graphically a bearing deviation angle between an aircraft and two candidate runways;

FIG. 4 is a top view illustrating graphically a track deviation angle between an aircraft and two candidate runways;

FIG. 5 is a side view illustrating graphically a glideslope deviation angle between an aircraft and two candidate runways;

FIG. 6 is a nonlimiting graphic representation of a likelihood as a function of a bearing deviation angle;

FIG. 7 is a nonlimiting graphic representation of a likelihood as a function of a track deviation angle;

FIG. 8 is a nonlimiting graphic representation of a likelihood as a function of a glideslope angle; and

FIG. 9 is a flowchart of the operations performed to predict upon which of at least two candidate runways that an aircraft is most likely to land according to one embodiment.

### DETAILED DESCRIPTION OF THE PREFERRED EMBODIMENT

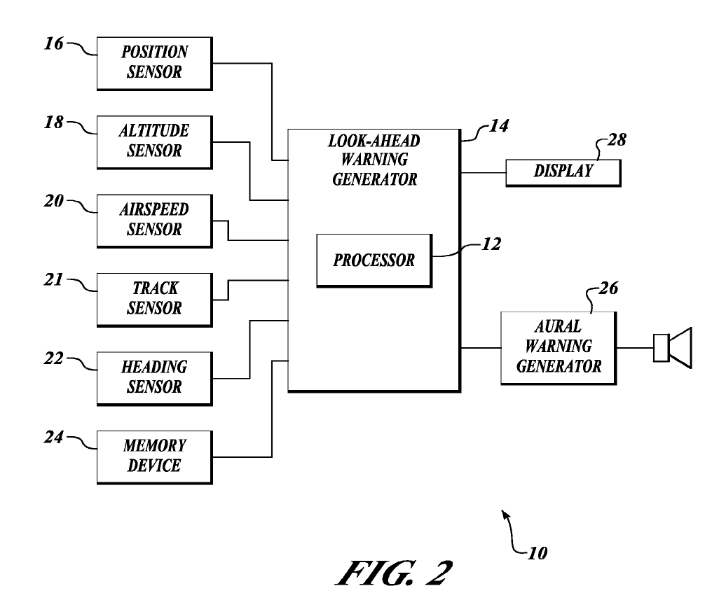

With relation to the description of the various embodiments provided in detail below, it must be understood that the present invention can be used with any system that uses information concerning runways for system calculations. Referring now to FIG. 2, an apparatus 10 for predicting from at least two candidate runways which runway an aircraft is most likely to land upon according to one embodiment of the present invention, is depicted in conjunction with a ground proximity warning system such as that described in U.S. Pat. No. 6,304,800 entitled, “Methods, Apparatus, and Computer Program Products for Automated Runway Selection” and incorporated herein by this reference. FIG. 2 depicts many of the components of the ground proximity warning system of U.S. Pat. No. 6,304,800 in simplified block form for illustrative purposes, however, it is understood that the functions of these blocks are consistent with and contain many of the same components as the ground proximity warning system described in U.S. Pat. No. 6,304,800.

With reference to FIG. 2, the apparatus 10 for predicting upon which runway, of at least two candidate runways, that an aircraft is most likely to land includes a processor 12 located in or, alternately, in communication with the look-ahead warning generator 14. The processor 12 is configured to receive information a position sensor 16, an altitude sensor 18, an airspeed sensor 20, a track sensor 21, and a heading sensor 22. Based upon a derived position and track, the look-ahead warning generator 14 uses the processor 12 to predict the likely runway based upon data stored in association with terrain proximate to the derived position. Specifically, the apparatus 10 of this embodiment includes a look-ahead warning generator 14 that generates the approach envelope 66, retrieves terrain data from a memory device 24 and using a processor 12 compares the retrieved terrain data to the approach envelope 66 to test for incursion of terrain into the approach envelope 66. If an incursion is found into the approach envelope 66, the candidate runway corresponding to the approach envelope 66 into which the terrain incurs is deemed no longer to be a candidate runway.

The look-ahead warning generator 14, bases the approach envelope on altitude data from the altitude sensor 18, position data from the position sensor 16, a heading from the heading sensor 22, and optionally, from the track data from a track sensor 21, and a ground speed of the aircraft derived from the position sensor and, again, optionally from an airspeed sensor 20. The position sensor may include a global positioning system (GPS), inertial navigation system (INS), or a flight management system (FMS). The look-ahead warning generator 14 also receives altitude and airspeed data from the altitude sensor 18 and the airspeed sensor 20, respectively, and the aircraft track and heading information from track and heading 21, 22 sensors, respectively. In addition to receiving data concerning the aircraft 62, the look-ahead warning system also receives data concerning the terrain surrounding the aircraft. Specifically, the look-ahead warning generator 14 is also connected to the memory device 24 that contains a searchable database of data relating, among other things, to the position and elevation of various terrain features and elevation, position, and quality information concerning runways.

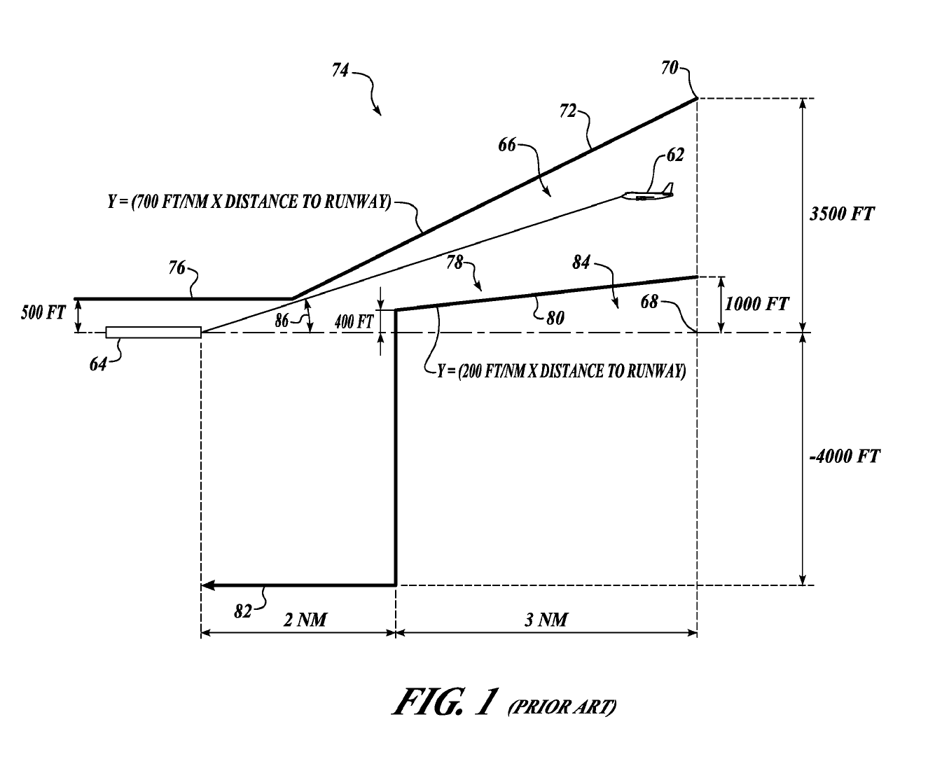

As depicted in FIG. 1, the approach envelope 66 is generated, in part, as a function of distance from the candidate runway 64. The minimum height by which the altitude of the aircraft 62 exceeding the retrieved terrain data varies as a function of distance from the candidate runway 64 in order to avoid activation of a warning. Because the height varies as the distance from the candidate runway, selecting the appropriate candidate runway allows for accurate definition of the approach envelope 66.

Ground proximity warning systems that typically select the candidate runway 64 closest to the aircraft 62 may generate a look-ahead envelope 66 (FIG. 1) for the wrong candidate runway 64 causing undue warnings to sound because the lower landing envelope floor 78 and the upper landing ceiling 72 will not coincide for any two candidate runways. Accurate prediction on which runway the aircraft 62 will land allows use of the information related to the predicted runway to generate the appropriate approach envelope 66 (FIG. 1).

Referring to FIGS. 1 and 3, the term “bearing deviation angle” is one criterion to determine the appropriate candidate runway. Bearing deviation angles 36, 38 are angles determined as a deviation of a candidate runway 32, 34 bears from the instantaneous horizontal path 31 of an aircraft 30. Comparison of the bearing deviation angles 36, 38 may resolve the prediction of most likely runway where there are at least two candidate runways. In this example, two candidate runways include a first candidate runway 32 and a second candidate runway 34. The first bearing deviation angle 36 is derived based upon the position of the aircraft 30 and a centerline. Similarly, relative to the second candidate runway 34, a second bearing deviation angle 38 is derived. Comparison of bearing deviation angles assists in prediction of the appropriate candidate runway, 32, 34.

Referring to FIG. 3, though comparing a magnitude of the first bearing deviation angle 36 to that of the second bearing deviation angle 38 may generally help to predict a most likely candidate runway 32, 34 from, for example, the first candidate runway 32 and the second candidate runway 34, doing so might, in other situations, yield the wrong selection, as where the altitudes of the runways 32, 34 differs significantly. For instance, where neither the magnitude of the first bearing deviation angle 36 nor of the second bearing deviation angle 38 are sufficiently great to rule out either as a candidate runway or sufficiently distinct as to determine which of the two candidate runways, additional information is necessary to predict the appropriate candidate runway 32, 34.

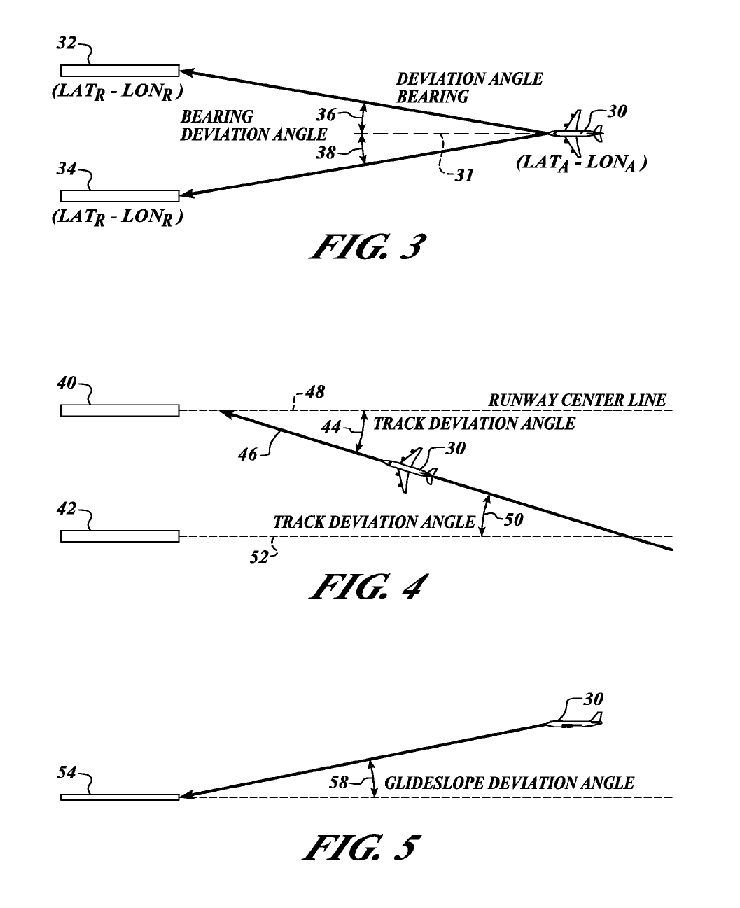

As shown in FIG. 4, to enhance prediction as to on which of the candidate runways that the aircraft 36 is most likely to land, a track deviation angle 44, 50 associated with each candidate runway 40, 42 is derived. The track deviation angles 44, 50 is distinct from the bearing deviation angles 44, 50 in that the bearing deviation angle is derived from angle 36, 38 each of the two candidate runways bears to the instantaneous horizontal path 31 of the aircraft 30, whereas the track deviation angles 36, 38 are the angle 44, 50 that the instantaneous horizontal path 46 of the aircraft 30 bears to a centerline of the runway 40, 42.

Like the bearing deviation angles 36, 38, the track deviation angles 44, 50 include information assistive in predicting the runway on which the aircraft 30 is most likely to land. In addition, like the bearing deviation angles 36, 38, selecting the angle of lesser magnitude is likely but not conclusive on predicting the runway on which the aircraft is most likely to land. The aircraft 30 may, from time to time turn on approach which, for instance in the course of a “carrier turn” prior to landing, the track deviation angle 44, 50 is constantly reducing until the aviator has aligned the aircraft 30 with the runway prior to landing.

FIG. 5 illustrates a glide slope deviation angle 58 of the aircraft 30 bears from an endpoint of a candidate runway 54. Specifically, glide slope deviation angle 58 represents the vertical deviation angle between the position of the aircraft 30 and the position of the first runway 54.

Typically, when landing the aircraft 30 according to a safe final approach to the runway 54, the glide slope deviation angle 58 will fall within a predetermined range of vertical angles. For commercial aircraft, the glide slope deviation angle 58 will fall within a range of about 0 degrees to about +7 degrees. Glide slope deviation angles 58 outside of the range unduly stress the aircraft 30 as it maneuvers into a safe glide slope. The approach envelope 66 (FIG. 1) envelopes based upon the candidate runway 54 that suitable envelope glide slopes having deviation angles 58 within the range allow prediction as candidate runways 54.

An embodiment of the invention includes the ascertaining and predicting of suitable approaches according to a particular candidate runway. Where terrain; prevailing weather; or other obstacle makes either a steeper or a shallower slope a more appropriate glide slope deviation angle than a default glide slope deviation, a modifying glide slope deviation angle is retrieved in association with the candidate runway 54. A means of developing such a stored glide slope deviation angle is through empirical collection of angles selected by pilots landing at a designated runway.

In the embodiment portrayed at FIG. 2, the processor 12 will retrieve order the look-ahead warning generator 14 to retrieve the glide slope angle 86 associated with each of a number of candidate runways (FIG. 1) in proximity to the aircraft 62 (FIG. 1) from the memory device 24. As the pilot performs the landing, the processor 12 develops the glide slope angle 86 for each of the monitored candidate runways.

Each stored glide slope angle 86 is the angle associated with each of the candidate runways. Such glide slope angles 86 may be derived to be an empirical angle or it may be a default angle of three degrees to horizontal. The empirical angle is, as suggested, an angle that is arrived at by observation of landings on the runway and may optionally include an averaging constant to adjust the glide slope angle according to repeated observations of glide slope angles when landing on the runway in question. The glide slope angle is observed and compared to that which is then retrieved due to association with the runway to which the aircraft is proximate. The retrieved value is used to decide the appropriate runway from among the candidate runways 64. Upon landing on one of the candidate runways, the processor 12 will ascribe the glide slope angle observed to the runway upon which the pilot landed the aircraft 62 and will suitably average the observed glide slope angle with the stored glide slope angle 86 associated with this candidate runway 64, optionally using the averaging constant, and store the result to replace the stored glide slope angle 86 associated with the candidate runway 64 to further refine the value of the stored glide slope angle 86.

Alternatively, an angle for suitable approach to a runway may be defined by an Instrument Landing System (“ILS”) in place for that runway. An approach using ILS is generally known as an instrument approach and generally is used where visual cues are not present to the pilot because such are obscured by weather or lighting. An instrument approach is an approach where radio transmitters give the pilot of an aircraft visual cues generated on the face of an aircraft's instruments. If the pilot follows these generated visual cues, the aircraft will arrive near the approach end of the runway, usually 200 feet above the surface. The selected angle for instrument approaches is the same angle that, in this embodiment, is used as the recalled stored glide slope angle 86 associated with this candidate runway 64. The highest likelihood of landing, then, is according to the instrument landing approach as the ILS system defines it. Therefore where an ILS angle is available, an embodiment defaults to recalling that angle in favor of deriving an empirical angle.

Referring to FIGS. 3 and 6, a function curve 87 is configured to indicate a likelihood that the aircraft 30 will land on the selected candidate runway 32, based upon the bearing deviation angle 36. Because the function curve 87 is known to be symmetric about the centerline of the runway 32, 34, the function need only be portrayed as extending from 0 to 180 degrees, where the bearing deviation angle may be a right deviation angle 36 or a left deviation angle 38. The function curve 87 as portrayed in nonlimiting example, includes three significant regions: an operational region 88, a transitional region 89, and a nonoperational region 90.

The probability function of the bearing deviation angle has a maximum likelihood arbitrarily set at a value of one to represent a maximum likelihood of landing on the candidate runway 32, 34. The maximum value is found at zero degrees to represent alignment on an instantaneous horizontal path 31 with the centerline of the runway. In general practice, such alignment is indicative of an intent to land on the runway with which the aircraft 30 is aligned. From the value of one, the magnitude of the function and thus the function curve 87 falls off gradually as the deviation angle bearing reaches the conventional maximum for generally acceptable commercial practices (the operational region 88). At the point of the conventional maximum bearing deviation angle for generally acceptable commercial practices, the likelihood is set at a second arbitrary value indicative of a lesser likelihood, proportionally lesser in magnitude than the likelihood of landing on a runway with which the aircraft is suitably aligned.

The function curve 87 moves to the transition region 89 at the conventional maximum deviation angle for generally acceptable commercial practices, and falls off as the deviation angle increases to the functional maximum deviation angle for the aircraft 30. From the functional maximum deviation angle to 180 degrees, the likelihood of landing is represented as zero in the non-operational region 90.

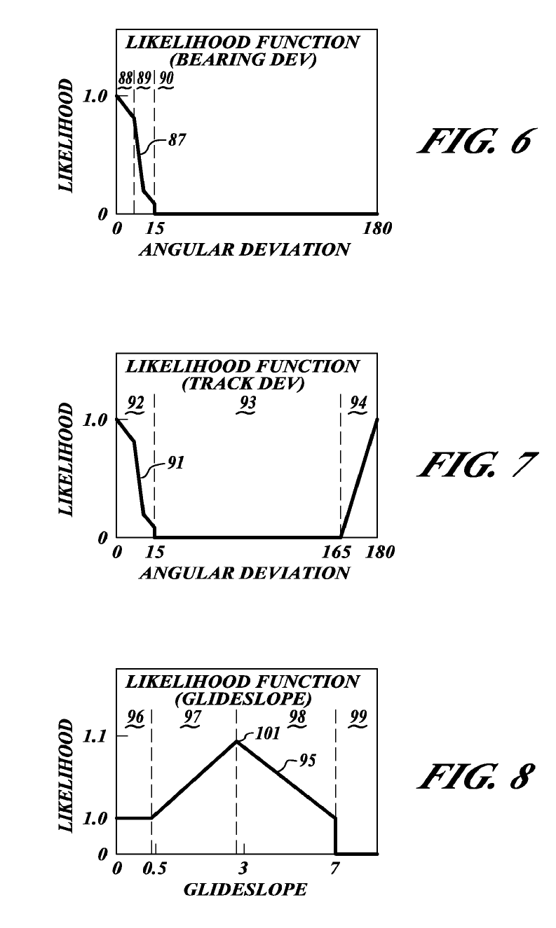

Similarly, referring to FIGS. 4 and 7, a function curve 91 indicates the likelihood that the aircraft 30 will land on the selected candidate runway 40 based upon a track deviation angle 44. The function curve 91 plotted against likelihood values ranging between zero and one on the y-axis reflecting a likelihood continuously as a function of the reference angle ranging from 0 to 180 degrees along the x-axis (likelihood being a symmetric function around the origin). The likelihood function 91 is based upon the track deviation angle 44, 50 from the centerline at 0-degrees or at 180-degrees includes a landing operational region 92, an oblique region 93, and a takeoff operational region 94.

Within the landing operational region 92, likelihood of landing on the candidate runway declines from a maximum value, arbitrarily set at a value of one where, as with predicting a candidate runway based upon the bearing deviation angle, where the instantaneous horizontal path 31 of the aircraft 30 aligns with a centerline of a candidate runway 40, 42 or at zero degrees. From the maximum value of one at zero degrees, the likelihood of the aircraft 30 landing on the candidate runway drops relatively rapidly to a value of zero at the operational maximum track deviation angle 44, 50. In the oblique region 93, the track deviation angle 44, 50 exceeds the operational limits of the aircraft 30 and thus, the likelihood of landing on the candidate runway 40, 42 and likewise the likelihood function curve 91 remains at the value zero throughout the oblique region 93.

The takeoff operational region 94 is used to increase rather than to decrease the floor threshold 80 (FIG. 1) as the aircraft 30 departs the runway. The likelihood function curve 91 climbs as the aircraft track more closely aligns with the centerline of the candidate runway.

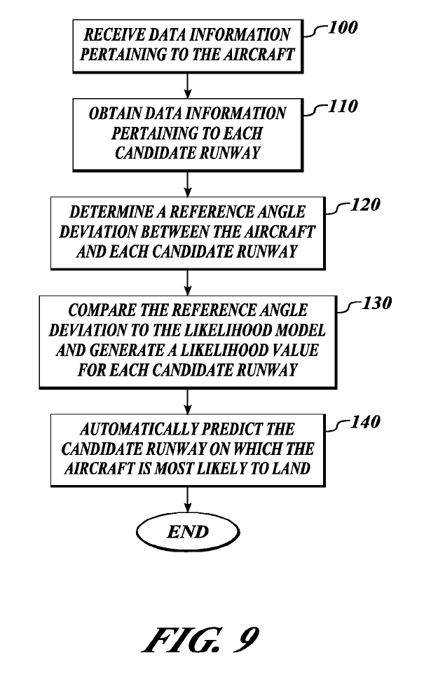

Referring to FIGS. 5 and 8, a function curve 95 includes a level flight region 96, a shallow approach region 97, a steep approach region 98, and a flyover region 99. Typically, commercial flight falls within the shallow approach region 97 and the steep approach region 98, the boundary between the two regions being the optimal glide slope, where the point of maximum likelihood of landing on the candidate runway occurs, by definition. An embodiment stores a point of maximum likelihood 101 in association with each candidate runway in the memory device 24 (FIG. 2). For most candidate runways 54, the glide slope deviation angle 58 at which the point of maximum likelihood 101 occurs is about three degrees. An embodiment allows the point of maximum likelihood 101 to vary according to empirical data collected during landings on a candidate runway 54 with which the empirical data is associated. In another embodiment allows the point of maximum likelihood 101 to be configurably defined and stored in the memory storage device 24 (FIG. 2) in association with a particular candidate runway 54.

Allowing the point of maximum likelihood 101 to vary from three degrees allows the selection of the candidate runway where terrain surrounding the candidate runway forces either a steeper or shallower approach than the typical three degree approach.

Within the steep approach region 96, the likelihood function curve 95 drops off to a point that is defined by the operational limits of the aircraft 30. At the operational limit of the aircraft 30, the likelihood function curve 95 drops to a value of zero in the flyover region 99 reflecting the inability of the aircraft 30 to safely land according to an approach angle of magnitude within the flyover region 99.

In the level flight region 96, where the aircraft is at a same altitude or just slightly above the altitude of the candidate runway such that glide slope deviation angle 58 has a magnitude of between zero and one-half of a degree, the glide slope deviation angle 58 is measured as the deviation from the horizontal from a point at end of a runway. The likelihood is assigned a constant value of, in this nonlimiting example, one to indicate that, in commercial practice, an aircraft has a set likelihood of landing and, therefore, the likelihood function curve 95 remains at a lower likelihood in the level flight region 96.

From just below one-half degree to the point of maximum likelihood 101, the likelihood function curve 95 shows an increasing likelihood as the glide slope deviation angle 58 increases to the point of maximum likelihood 101. Again, the value assigned to a peak value of 1.1 in this nonlimiting example is an arbitrary one reflecting a statistically higher likelihood at the point of maximum likelihood 101.

Referring as well to FIGS. 2, 5, 8, and 9, the processor 12 receives flight position data, at a block 100, from the various sensors 16, 18, 20, 21, and 22 in order to determine a position of the aircraft 30, a track of the aircraft 30, and a heading of the aircraft 30.

Based upon a position of the aircraft 30, the processor 12 retrieves from the memory device 24, all data relating to each candidate runway 54 within a designatable radius of the aircraft 30 position, at a block 110. Each of the candidate runways 54 are associated with unique data including an empirical glide slope deviation angle 58 stored in the memory device 24.

The data associations for each candidate runway 54 within the designatable radius are used to determine the glide slope deviation angle 58 corresponding to each candidate runway 54, at a block 120. At a block 130, the processor 12 derives a value of the likelihood of landing function curve 95 associated with the candidate runway 54 at each measured glide slope deviation angle 58 associated with each candidate runway 54. The processor 12 selects the candidate runway associated with the greatest of the derived likelihood of landing values as the predicted runway at a block 140.

Because each of the likelihood function curves 95 used by the processor 12 is unique and associated with the candidate runway 54, the likelihood value derived, even from similar glide slope deviation angles 58 may be very different. Thus, where a first candidate runway 54 having obstructing terrain preventing a three-degree approach has a four-degree point of maximum likelihood 101, the processor 12 is more likely to predict a second candidate runway 54 at an equal altitude where no obstructing terrain exists.

Referring to FIGS. 2, 6, 7, 8, and 9, the method determines a likelihood of landing by means of determining a most likely runway based upon likelihoods of landing based upon each of three landing likelihood functions, that of the bearing angular deviation function 87, the track angle deviation function 91, and the glide slope angular deviation 95 with a configurable local maximum likelihood 101 based upon an empirical glide slope angle, the empirical glide slope angle being the angle by which the greatest number of aircraft approach the runway with which the empirical glide slope angle is associated in the database. Multiple means exist to arrive at a ranking candidates on a to derive a composite likelihood. One enabling means is by a weighted average that allows values derived based upon multiplying each of the bearing angular deviation function 87, the track angle deviation function 91, and the glide slope angular deviation 95 by suitable weighting constants. The resulting likelihood is a composite likelihood used then to rank the runways to predict a runway for landing.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. An apparatus for predicting which one of at least two candidate runways on which an aircraft is most likely to land, the apparatus comprising:
a database configured to contain at least two runway data, each candidate runway data including an empirical glide slope angle and a location associated with the candidate runway;
a position sensor, the position sensor configured to determine a position of the aircraft; and
a processor configured to retrieve the glide slope angle and location data associated with each of the at least two candidate runways, to calculate an aircraft glide slope angle relative to each of the at least two candidate runways based upon the position of the aircraft, and to derive a first likelihood of landing value for each of the at least two candidate runways based upon the empirical glide slope angle and the aircraft glide slope angle associated with the candidate runway and to rank the at least two candidate runways according to the first likelihood of landing value thereby to predict one of the at least two candidate runways.

2. The apparatus of claim 1, further comprising:
a track sensor configured to generate a track angle signal indicative of a track angle deviation relative to each of the at least two candidate runways; and
wherein the processor is further configured to derive a second likelihood of landing value based upon the track angle deviation and derive a first composite likelihood of landing value based upon the first likelihood of landing value and the second likelihood of landing value and to rank the at least two candidate runways according to the composite likelihood of landing value thereby to predict one of the at least two candidate runways.

3. The apparatus of claim 1, further comprising:
a heading sensor configured to generate a heading signal indicative of a heading deviation relative to each of the at least two candidate runways; and
wherein the processor is further configured to derive a third likelihood of landing value based upon the heading deviation and derive a second composite likelihood of landing value based upon the first likelihood of landing value and the third likelihood of landing value.

4. The apparatus of claim 1, further comprising:
a track sensor configured to generate an track signal indicative of a track angle relative to each of the at least two candidate runways; and
wherein the processor is further configured to derive a fourth likelihood of landing value based upon the track and derive a third composite likelihood of landing value based upon the first likelihood of landing value and the fourth likelihood of landing value.

5. The apparatus of claim 1, further comprising:
an altitude sensor configured to generate a signal indicative of altitude of the aircraft; and
wherein the processor is further configured to derive a fifth likelihood of landing value based upon the altitude, and derive a fourth composite likelihood of landing value based upon the first likelihood of landing value and the fifth likelihood of landing value.

6. The apparatus of claim 1, wherein deriving the first likelihood of landing value is based upon an empirical glide slope angle associated with each of the at least two candidate runways.

7. The apparatus of claim 1, wherein deriving the first likelihood of landing value is based upon an ILS glide slope angle associated with each of the at least two candidate runways.

8. The apparatus of claim 6, wherein the empirical probability model is a function based upon the empirical glide slope angle associated with each of the at least two candidate runways.

9. The apparatus of claim 1, wherein the processor is further configured to rank the at least two candidate runways according to the first likelihood of landing value.

10. The apparatus of claim 9, wherein the processor is further configured to rank the at least two candidate runways based upon a group consisting of the first composite likelihood of landing value, the second composite likelihood of landing value, the third composite likelihood of landing value, and the fourth composite likelihood of landing value.

11. A computer database residing on a computer readable medium, the database comprising:
runway data stored in association with each of a plurality of runways including:
a location datum, the location datum configured to fix the runway in a spherical coordinate system; and
an empirical glide slope angle, the empirical glide slope angle selected to represent a most likely glide slope to approach the runway.

12. The database of claim 11, wherein the empirical glide slope angle is the ILS angle associated with the runway.

13. The database of claim 12 wherein, the runway data further comprises: an empirical probability model based upon the empirical glide slope angle.

14. The database of claim 12 wherein the empirical probability model is further based upon an airspeed.

15. The database of claim 12 wherein the empirical probability model is further based upon a heading angle.

16. The database of claim 12 wherein the empirical probability model is further based upon an approach track angle.

17. A method for predicting which one of at least two candidate runways on which an aircraft is most likely to land, wherein said method comprises:
deriving an aircraft position based upon input from a position sensor;
calculating a glide slope angle associated with each of two candidate runways based upon the aircraft position;
deriving a first likelihood of landing value for each of the at least two candidate runways based upon the glide slope angle and an empirical probability model associated with the candidate runway; and
ranking each runway according to the likelihood of landing value.

18. The method of claim 17 wherein the empirical probability model is based upon an empirical glide slope stored in association with the runway.

19. The method of claim 18 further comprising:
calculating a track angle deviation for each runway; and
wherein the empirical probability model is further based upon a track angle deviation.

20. The method of claim 18 further comprising:
calculating a heading deviation each runway bears from the current heading of the aircraft; and
wherein the empirical probability model is further based upon a heading angle deviation.

21. The method of claim 18 wherein the empirical glide slope is an average of approach glide slopes observed at the runway.

22. The method of claim 17 wherein the empirical model is based upon approach glide slopes observed at the runway.

23. The method of claim 17 wherein the empirical model is based upon approach ILS glide slope at the runway.
